(19) United States
(12) Patent Application Publication
(10) Pub. No.: US 2016/0009222 A1
(43) Pub. Date: Jan. 14, 2016

(54) EMERGENCY ALERT AUDIO INTERCEPTION

(71) Applicant: Eugene Taylor, Rancho Cucamonga, CA (US)

(72) Inventor: Eugene Taylor, Rancho Cucamonga, CA (US)

(21) Appl. No.: 14/795,871

(22) Filed: Jul. 9, 2015

Related U.S. Application Data
(60) Provisional application No. 62/022,317, filed on Jul. 9, 2014.

(51) Int. Cl. B60Q 5/00; B60Q 1/26

(52) U.S. Cl. CPC B60Q 5/006; B60Q 1/26

(57) ABSTRACT

Apparatuses, systems, and methods are disclosed for emergency alert audio interception. An emergency module is configured to determine that an emergency condition has been satisfied for a first vehicle. A transmitter module is configured to transmit an emergency indication from a first vehicle to a different vehicle. A receiver module is configured to detect, at a different vehicle, an emergency indication from a first vehicle. An action module is configured to perform an automatic action for a different vehicle in response to detecting an emergency indication.

### CROSS-REFERENCES TO RELATED APPLICATIONS

This application claims the benefit of U.S. Provisional Patent Application No. 62/022,317 entitled “EMERGENCY AUDIO INTERCEPTION” and filed on Jul. 9, 2014, for Eugene Taylor, which is incorporated herein by reference.

### FIELD

This invention relates to vehicle safety and more particularly relates to emergency alert audio interception.

### BACKGROUND

Emergency vehicles, trains, or the like often present disruptions to the regular flow of traffic. Most emergency vehicles and trains are equipped with devices that emit loud auditory signals, warning the operators of other vehicles that an emergency vehicle or train is approaching. With warning, a vehicle operator can navigate his or her vehicle in such a way as to allow the emergency vehicle or train to quickly and easily pass. Once the emergency vehicle or train passes, traffic can resume as normal. However, if a vehicle operator is not made aware of an approaching emergency vehicle or train, the risk of collision is greatly increased. Entertainment and communication device usage in vehicles presents at least one reason why a vehicle operator might not be made aware of an approaching emergency vehicle or train. Further, as the quality of vehicles improves, the degree to which vehicles are insulated from exterior sounds is increasing as well, thus reducing the vehicle operator's opportunity to hear an approaching emergency vehicle or train.

Most vehicles are equipped with a sound system for playing audio from devices such as radios, tape, CD or DVD players, Bluetooth communication systems, and other media devices connected to the sound system. When the sound system is in use, a vehicle operator risks not hearing an emergency vehicle siren or train horn. As a result, the vehicle operator is at risk of colliding with an emergency vehicle or train. This can result in severe personal injury and/or property damage. Especially in the case of emergency vehicles, collisions with other vehicles can prevent emergency responders from reaching individuals that may be in critical need of help.

### SUMMARY

Apparatuses for emergency audio interception are presented. In one embodiment, an emergency module is configured to determine that an emergency condition has been satisfied for a first vehicle. A transmitter module, in certain embodiments, is configured to transmit an emergency indication to one or more different vehicles to trigger an automatic action in one or more different vehicles.

In one embodiment, an emergency indication includes a radio signal with a predetermined transmission radius from a first vehicle. In a further embodiment, an emergency module is configured to dynamically adjust a transmission radius based on an emergency condition. In one embodiment, the emergency module is configured to dynamically adjust the transmission radius based on a speed of the first vehicle. In certain embodiments, the emergency module is configured to dynamically adjust the transmission radius based on a speed of the one or more different vehicles such that the one or more different vehicles remain within the transmission radius for at least a predetermined amount of time. In one embodiment, an emergency indication includes an optical signal. One or more different vehicles, in certain embodiments, are configured to detect an optical signal and to perform an automatic action.

In one embodiment, an automatic action includes a visual alert to a driver of one or more different vehicles. In a further embodiment, an automatic action includes powering off a sound system in one or more different vehicles in response to receiving an emergency indication. In one embodiment, an automatic action includes an auditory alert to a driver of one or more different vehicles.

In one embodiment, an emergency condition is satisfied in response to a siren of a first vehicle being engaged. In a further embodiment, an emergency condition is satisfied in response to a first vehicle approaching an intersection. In one embodiment, a first vehicle includes an emergency response vehicle, a train, or a public transportation vehicle.

A receiver module, in a further embodiment, is configured to detect an emergency indication from a first vehicle to a different vehicle. In one embodiment, an action module is configured to perform an automatic action in a different vehicle in response to detecting an emergency indication.

In one embodiment, a receiver module and an action module comprise a hardware device. In certain embodiments, a hardware device includes one or more audio inputs that receive audio signals from a sound system of a different vehicle. In a further embodiment, a hardware device includes one or more audio outputs that communicate audio signals to one or more speakers of a different vehicle. In a further embodiment, an action module is configured to perform an automatic action on received audio signals within a hardware device between one or more audio inputs and one or more audio outputs.

In one embodiment, an emergency indication includes a radio signal with a predetermined transmission radius from a first vehicle. In a further embodiment, a receiver module includes a radio receiver configured to detect a radio signal in response to a different vehicle being within a predefined transmission radius from a first vehicle. In one embodiment, an emergency indication includes an optical signal. In certain embodiments, a receiver module includes a sensor configured to detect an optical signal. In one embodiment, an optical signal includes one or more siren lights of an emergency vehicle. In another embodiment, a sensor includes a rearview camera of a different vehicle. In one embodiment, a receiver module is configured to detect a pattern of siren lights in one or more images from a rear view camera.

In one embodiment, an automatic action includes powering off a sound system of a different vehicle in response to a receiver module detecting an emergency indication. In another embodiment, a sound system includes a radio system, a compact disk system, and/or a digital video disk system. In one embodiment, an automatic action includes a visual alert to a driver of a different vehicle and/or an auditory alert to a driver of a different vehicle.

Systems for emergency audio interception are presented. In one embodiment, an emergency module is configured to determine that an emergency condition has been satisfied for a first vehicle. A transmitter module, in certain embodiments, is configured to transmit an emergency indication from a first vehicle to a different vehicle. In a further embodiment, a receiver module is configured to detect, at a different vehicle, an emergency indication from a first vehicle. An action module, in one embodiment, is configured to perform an automatic action for a different vehicle in response to a receiver module detecting an emergency indication. In one embodiment, a system includes a first vehicle. In another embodiment, a system includes a different vehicle.

Methods for emergency audio interception are presented. In one embodiment, a method includes determining that an emergency condition has been satisfied for a first vehicle. A method, in a further embodiment, includes transmitting an emergency indication from a first vehicle to a different vehicle. In certain embodiments, a method includes detecting, at a different vehicle, an emergency indication from a first vehicle. A method, in one embodiment, includes performing an automatic action for a different vehicle in response to detecting an emergency indication from a first vehicle.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a system for vehicle safety;

FIG. 2A is a schematic block diagram illustrating one embodiment of an emergency alert module;

FIG. 2B is a schematic block diagram illustrating one embodiment of an audio interception module; and

FIG. 3 is a schematic flow chart illustrating an embodiment of a method for emergency alert audio interception.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

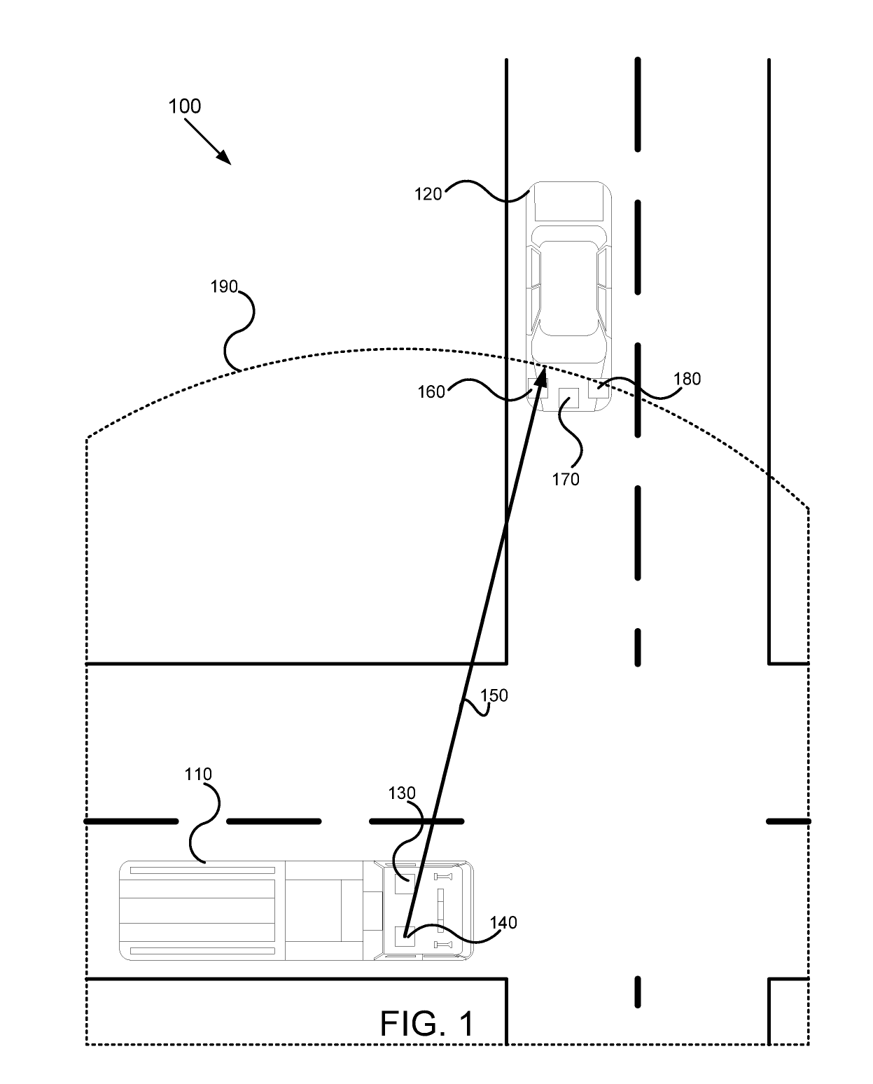

FIG. 1 depicts one embodiment of a system 100 for emergency alert audio interception. The system 100, in the depicted embodiment, includes a first vehicle 110, one or more different vehicles 120, an emergency module 130, a transmitter module 140, an emergency indication 150, a receiver module 160, an action module 170, a sound system 180, and a transmission radius 190. In certain embodiments, the emergency module 130 and the transmitter module 140 are configured to send the emergency indication 150 to the receiver module 160 of the one or more different vehicles 120, so that the action module 170 may perform an automatic action, such as stopping sound from a sound system 180 in the different vehicle 120 while the different vehicle 120 is within the transmission radius 190 during an emergency condition, or the like.

The first vehicle 110, in one embodiment, may comprise an emergency response vehicle, such as a police vehicle, an ambulance, a fire engine, or another type of emergency vehicle. In another embodiment, the first vehicle 110 may comprise a train, a trolley, a bus, a public transportation vehicle, or the like. In some embodiments, the first vehicle 110 may be manufactured with the emergency module 130 and/or the transmitter module 140. In one embodiment, the emergency module 130 and/or the transmitter module 140 may be integrated with a siren, a horn, warning lights, or the like of the first vehicle 110. In another embodiment, the first vehicle 110 may be configured to accept the emergency module 130 and/or the transmitter module 140, as an after-market upgrade, add-on, or the like. In a further embodiment, the emergency module 130 and/or the transmitter module 140 may be configured to operate independently of the first vehicle 110, as an independent unit (e.g., a battery powered device, a mobile device of a driver or passenger of the first vehicle 110, a device at an intersection or traffic sign, or the like).

The one or more different vehicles 120, in one embodiment, may be manufactured with the receiver module 160, the action module 170, and/or the sound system 180. For example, in such an embodiment, the sound system 180 may be manufactured with one or more of the receiver module 160 and the action module 170. In another embodiment, the receiver module 160 and/or the action module 170 may be compatible with one or more different types or brands of sound systems 180, and may be installed during manufacture of the sound system 180, during manufacture of the one or more different vehicles 120, as an after-market upgrade, add-on, or the like. The one or more different vehicles 120, in certain embodiments, may be configured to accept the receiver module 160, the action module 170, and/or the sound system 180. For example, in various embodiments, the receiver module 160 and/or the action module 170 may be installed in electrical communication with a power supply or power supply line of the sound system 180, one or more audio lines of the sound system 180, a fuse or circuit breaker for the sound system 180, a visual alert device such as a dashboard light or icon, a rearview mirror light or icon, an image or icon on a screen for a backup or rearview camera (e.g., an image or icon of an emergency vehicle), a steering wheel light or icon, a windshield projection light or icon, or the like, of a different vehicle 120. In embodiments where the receiver module 160 and/or the action module 170 is installed on or along an audio line (e.g., a speaker wire) for the sound system 180, to stop or interrupt sound from the sound system 180 or the like, a driver or operator of the different vehicle 120 may continue to use other functions of the sound system 180, without audio, such that the driver or operator may more easily here a siren, horn, or other alert from the first vehicle 110. In one embodiment, the receiver module 160, the action module 170, and/or the sound system 180 may be configured to operate independently of the one or more different vehicles 120 (e.g., a battery powered device, a mobile device of a driver or passenger of a different vehicle 120, or the like).

In one embodiment, the receiver module 160 and/or the action module 170 may comprise a hardware device, with one or more electrical circuits, integrated circuits, printed circuit boards, or the like. In one embodiment, the hardware device may include one or more audio inputs configured to receive audio signals from the sound system 180 of the different vehicle 120. In a further embodiment, the hardware device may include one or more audio outputs configured to send the received audio signals to one or more speakers of the different vehicle 120. For example, in one embodiment, the hardware device may include one or more power inputs, audio inputs, and/or audio outputs. One or more audio lines may connect to the audio input and communicate audio signals from the sound system 180 to the hardware device. One or more audio lines may connect to the audio output and send audio signals to the one or more speakers of the different vehicle 120.

In one embodiment, the action module 170 may be configured to perform an automatic action on the received audio signals within the hardware device between the one or more audio inputs and the one or more audio outputs. For example, the action module 170, in one embodiment, may include an electrical switch configured to selectively interrupt transmission of an audio signal to the one or more speakers of the different vehicle 120, in response to the receiver module 160 detecting an emergency indication, or the like. In a further embodiment, the action module 170 may be configured to play an emergency message, alert, or other sound over the one or more speakers of the different vehicle 120, instead of relaying audio from the sound system 180, in response to the receiver module 160 detecting an emergency indication, or the like. The hardware device, in one embodiment, may be independent and/or separate from the sound system 180, and may be installed behind the sound system 180 (e.g., in a wire harness of the different vehicle 120) and/or in another location in the different vehicle 120.

In one embodiment, including a hardware device that is separate from the sound system 180 may allow the hardware device to more easily be installed. In a further embodiment, the action module 170 selectively interrupting the transmission of an audio signal to the one or more speakers of the different vehicle 120 may allow the sound system 180 to continue to function without producing sound. In this manner, a user or operator of the different vehicle 120 may rewind play of media (e.g., a CD, DVD, video file, sound file, or the like) using the sound system 180 after interruption of the audio signal has ended and sound is restored. In one embodiment, interrupting the transmission of an audio signal to the one or more speakers may stop sound from the sound system 180 faster than powering off the sound system 180, may allow the sound system 180 to begin producing sound faster after an interruption, or the like. In a further embodiment, interrupting the transmission of an audio signal to the one or more speakers may prevent damage to the sound system 180 caused by interrupting power to the sound system 180 without completing a power down process.

In one embodiment, the system 100 may include an emergency indication 150. The emergency indication 150, in some embodiments, may be configured to notify the one or more different vehicles 120 of an emergency condition satisfied for the first vehicle 110. In some embodiments, the emergency indication 150 may include a transmission radius 190 from the first vehicle 110. The transmission radius 190 may, in some embodiments, include a predetermined and constant radius. In another embodiment, the transmission radius 190 may include a dynamically tunable and/or adjustable radius within a certain range, by the emergency module 130, by the transmitter module 140, by a user (e.g., a driver, operator, and/or passenger of the first vehicle 110), or the like. The transmission radius 190, in some embodiments, may be between one or more of about 1 and 100 yards, about 10 and 90 yards, about 20 and 80 yards, about 30 and 70 yards, about 40 and 60 yards, more than 100 yards, or the like. In other embodiments, the transmission radius 190 may be between one or more of about 1 and 80 yards, about 10 and 70 yards, about 20 and 60 yards, and about 1 and 50 yards, or the like. The transmission radius 190 may also be, in other embodiments, about 50 yards. The emergency module 130, in certain embodiments, may be configured to adjust the transmission radius 190 based on a type of emergency condition detected. For example, the emergency module 130 may cause the transmitter module 140 to use a larger transmission radius 190 for more serious emergencies, for emergencies affecting a larger area, or the like.

In one embodiment, the transmission radius 190 may include a dynamically tunable and/or adjustable radius and the transmitter module 140 may adjust the transmission radius 190 based on the speed of the first vehicle 110 and/or the speed of the one or more different vehicles 120. In this manner, the emergency indication 150 may arrive at the one or more different vehicles 120 and one or more modules (such as the action module 170) may alert an operator of a different vehicle 120 before the one or more different vehicles 120 exit the transmission radius 190. In a further embodiment, the transmitter module 140 may dynamically adjust the transmission radius 190 so that the one or more different vehicles 120 remain within the transmission radius 190 for at least a predetermined amount of time, the transmission radius 190 may be selected and/or determined so that the one or more different vehicles 120 remain within the transmission radius 190 for at least a predetermined amount of time (e.g., based on a maximum speed of the first vehicle 110 and/or the one or more different vehicles 120, based on an expected speed of the first vehicle 110 and/or the one or more different vehicles 120, based on a detected current speed of the first vehicle 110 and/or the one or more different vehicles 120, or the like). In another embodiment, in an embodiment where the emergency indication 150 includes a radio signal, the radio signal from the transmitter module 140 may be configured with a limited transmission radius 190, by using a predetermined transmission power, a predetermined transmission frequency, or the like for the radio signal of the emergency indication 150.

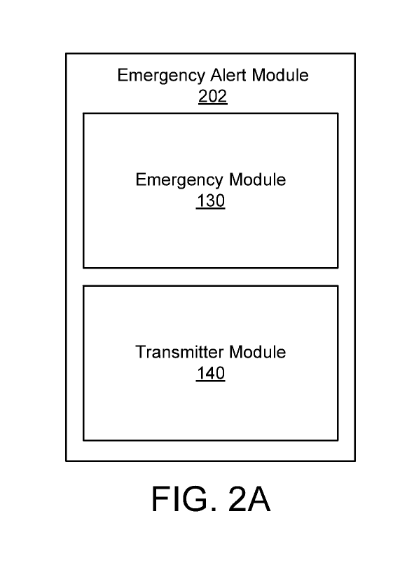

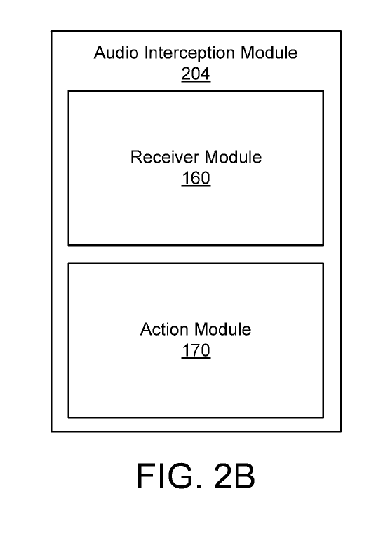

FIG. 2A depicts one embodiment of an emergency alert module 202. In one embodiment, the emergency alert module 202 may include the emergency module 130. In a further embodiment, the emergency alert module 202 may include the transmitter module 140. In one embodiment, the emergency module 130 may be configured to determine than an emergency condition has been satisfied for a first vehicle 110. In a further embodiment, the transmitter module 140 may be configured to transmit an emergency indication 150 to one or more different vehicles 120 to trigger an automatic action in the one or more different vehicles 120.

In one embodiment, the emergency alert module 202 may include an emergency module 130. The emergency module 130, in one embodiment, may be configured to determine that an emergency condition has been satisfied for a first vehicle 110. An emergency condition, as used herein, may include an event detectable by the emergency module 130, for which it may be desirable for the first vehicle 110 to alert a different vehicle 120. For example, in one embodiment, the emergency module 130 may detect an emergency condition in response to a siren or horn of the first vehicle 110 being engaged. For example, in one embodiment, an operator, passenger, or the like of the first vehicle 110 engaging a siren or horn of the first vehicle 110 may include the operator, passenger, or the like activating the siren or horn. In further embodiment, the emergency module 130 may detect an emergency condition in response to the first vehicle 110 approaching an intersection (e.g., based on global positioning system (GPS) or other location data, detecting an intersection using a sensor, or the like). In a further embodiment, the emergency module 130 may detect an emergency condition in response to the first vehicle 110 satisfying a predefined speed threshold, a predefined acceleration threshold, the first vehicle 110 stopping to allow loading and/or unloading of passengers, or the like.

In another embodiment, the emergency alert module 202 may include a transmitter module 140. The transmitter module 140, in one embodiment, may be configured to transmit an emergency indication 150 to one or more different vehicles 120, to trigger an automatic action in the one or more different vehicles 120, or the like. In one embodiment, the transmitter module 140 may be configured to transmit an emergency indication 150 including a radio signal. In a further embodiment, the transmitter module 140 may be configured to transmit an emergency indication 150 including an optical signal, such as lights from a siren or the like. In one embodiment, the transmitter module 140 may be configured to transmit an emergency indication 150 that includes a Wi-Fi signal, Bluetooth® signal, radio frequency (RF) signal, broadband signal, cellular signal, electromagnetic signal, infrared signal, or the like.

FIG. 2B depicts one embodiment of an audio interception module 204. In one embodiment, the audio interception module 204 may include the receiver module 160. In another embodiment, the audio interception module 204 may include the action module 170. In one embodiment, the receiver module 160 may be configured to detect an emergency indication 150 from a first vehicle 110 to a different vehicle 120. The action module 170 may be configured to perform an automatic action in the different vehicle 120 in response to the receiver module 160 detecting the emergency indication 150.

In one embodiment, the audio interception module 204 may include a receiver module 160. In one embodiment, the receiver module 160 may be configured to receive or detect an emergency indication 150 transmitted from the transmitter module 140. For example, the receiver module 160 may include a radio frequency receiver configured to receive or detect a predefined radio frequency signal or message from the transmitter module 140, or the like. In a further embodiment, the receiver module 160 may include an optical receiver, such as a camera or the like, configured to receive or detect a predefined optical signal or message from the transmitter module 140. For example, the receiver module 160 may be configured to detect or distinguish a pattern of emergency siren lights from other types of lights or light patterns. In one embodiment, the receiver module 160 may be in communication with, integrated with, or may otherwise use images from one or more rearview cameras, or other optical sensors, to detect a pattern of siren lights (e.g., a predefined light intensity, a predefined pattern of light flashes, or the like) from an emergency vehicle. Re-using or adding additional uses to a rearview camera or other existing sensor, in certain embodiments, may reduce the incremental cost of the system 100, the emergency alert module 202, the audio interception module 204, or the like. In another embodiment, the receiver module 160 may be configured to receive or detect the emergency indication 150 including a Wi-Fi signal, Bluetooth® signal, radio frequency (RF) signal, broadband signal, cellular signal, electromagnetic signal, infrared signal, or the like from the transmitter module 140.

In one embodiment, the audio interception module 204 may include an action module 170. In one embodiment, in response to the receiver module 160 detecting an emergency indication 150 from the transmitter module 140, the action module 170 may, in one embodiment, be configured to perform an automatic action in the one or more different vehicles 120. In some embodiments, the action module 170 may perform an automatic action including powering off a sound system 180 in the one or more different vehicles 120. In other embodiments, the automatic action may include stopping or cutting sound from the sound system 180, or the like. In one embodiment, the action module 170 may be configured to perform the automatic action on received audio signals within a hardware device (such as the hardware device discussed above) between one or more audio inputs and one or more audio outputs.

For example, as discussed above, the action module 170, in one embodiment, may include an electrical switch configured to selectively interrupt transmission of an audio signal to the one or more speakers of the different vehicle 120, in response to the receiver module 160 detecting an emergency indication, or the like. In a further embodiment, the action module 170 may be configured to play an auditory alert over the one or more speakers of the different vehicle 120, instead of relaying audio from the sound system 180, in response to the receiver module 160 detecting an emergency indication, or the like. In another embodiment, the action module 170 may be configured to play an auditory alert over audio from the sound system 180. In a further embodiment, the action module may be configured to reduce the volume or mute audio from the sound system 180 while playing the auditory alert.

In one embodiment, an auditory alert may include a predefined or recorded emergency message, a message transmitted from an emergency vehicle as part of the emergency indication 150, or the like. In a further embodiment, the action module 170 may transmit or play an auditory alert from a speaker of the sound system 180, one or more speakers of the different vehicle 120, or, in embodiments where the sound system 180 is disabled, may include an independent, separate speaker for auditory alerts. The separate speaker may include a Bluetooth® speaker, a headset, or other auditory device. In another embodiment, the action module 170 may transmit or play an auditory alert without interrupting an audio signal from the sound system 180.

In another embodiment, the action module 170 may perform an automatic action including displaying a visual alert to a driver, operator, or passenger of the one or more different vehicles 120. The visual alert may include a dashboard light or icon, a rearview mirror light or icon, a steering wheel light or icon, a windshield projection light or icon, a warning light, text, or image on a digital display screen (such as a screen for a backup or rearview camera), or the like. In a further embodiment, the action module 170 may perform an automatic action including producing an auditory alert to a driver, operator, or passenger of the one or more different vehicles 120.

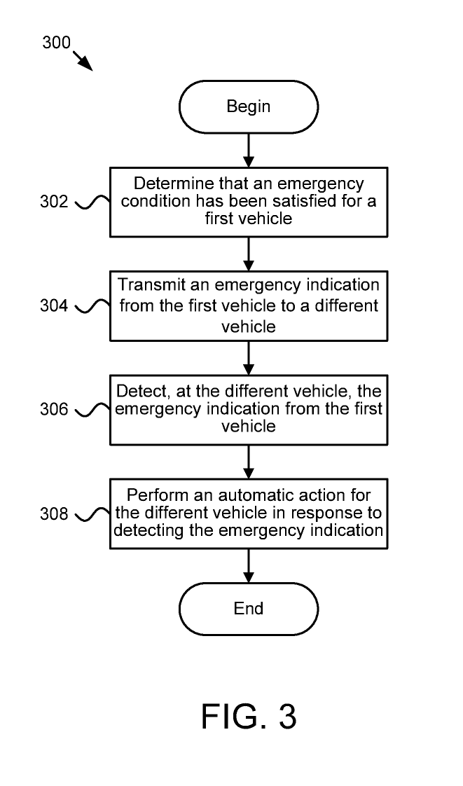

FIG. 3 depicts one embodiment of a method 300 for emergency alert audio interception. The method 300 begins and, in one embodiment, an emergency module determines 302 that an emergency condition has been satisfied for a first vehicle. For example, in one embodiment, the emergency module 130 may detect an emergency condition in response to a siren or horn of the first vehicle 110 being engaged. For example, in one embodiment, an operator, passenger, or the like engaging a siren or horn of the first vehicle 110 may include the operator, passenger, or the like activating the siren or horn. In another embodiment, the emergency module 130 may detect an emergency condition in response to the first vehicle 110 approaching an intersection. In a further embodiment, the emergency module 130 may detect an emergency condition in response to the first vehicle 110 satisfying a predefined speed threshold, a predefined acceleration threshold, or the first vehicle 110 stopping to allow loading and/or unloading of passengers, or the like.

In one embodiment, a transmitter module transmits 304 an emergency indication from a first vehicle to a different vehicle. For example, in one embodiment, the transmitter module 140, may transmit an emergency indication 150 from a first vehicle 110 to one or more different vehicles 120. The transmission of the emergency indication 150 or the like may trigger an automatic action in the one or more different vehicles 120. In one embodiment, the transmitter module 140 may transmit an emergency indication 150 and the emergency indication 150 may include a radio signal, an optical signal (such as lights from a siren or the like), a Wi-Fi signal, Bluetooth® signal, radio frequency (RF) signal, broadband signal, cellular signal, electromagnetic signal, infrared signal, or the like.

In one embodiment, a receiver module detects 306, at the different vehicle, the emergency indication from the first vehicle. For example, in one embodiment, the receiver module 160 may detect an emergency indication 150 transmitted from the transmitter module 140 of the first vehicle 110. In one embodiment, the receiver module 160 may include a radio frequency receiver, an optical receiver, a receiver for a Wi-Fi signal, Bluetooth® signal, radio frequency (RF) signal, broadband signal, cellular signal, electromagnetic signal, infrared signal, or the like.

In one embodiment, an action module performs 308 an automatic action for a different vehicle in response to detecting an emergency indication. For example, in one embodiment, in response to the receiver module 160 detecting an emergency indication 150 from the transmitter module 140, the action module 170 may perform an automatic action in the different vehicle 120. In some embodiments, the automatic action may include powering off a sound system 180 in the different vehicle 120, stopping or cutting sound from the sound system 180, displaying a visual alert, or producing an auditory alert.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for emergency audio interception, the apparatus comprising:
an emergency module configured to determine that an emergency condition has been satisfied for a first vehicle; and
a transmitter module configured to transmit an emergency indication to one or more different vehicles to trigger an automatic action in the one or more different vehicles.

2. The apparatus of claim 1, wherein the emergency indication comprises a radio signal with a predetermined transmission radius from the first vehicle.

3. The apparatus of claim 2, wherein the emergency module is configured to dynamically adjust the transmission radius based on the emergency condition.

4. The apparatus of claim 2, wherein the transmission radius is determined based on one or more of a speed of the first vehicle and a speed of the one or more different vehicles such that the one or more different vehicles remain within the transmission radius for at least a predetermined amount of time.

5. The apparatus of claim 1, wherein the emergency indication comprises an optical signal, the one or more different vehicles configured to detect the optical signal and to perform the automatic action.

6. The apparatus of claim 1, wherein the automatic action comprises one or more of:
a visual alert to a driver of the one or more different vehicles;
powering off a sound system in the one or more different vehicles in response to receiving the emergency indication; and
an auditory alert to a driver of the one or more different vehicles.

7. The apparatus of claim 1, wherein the emergency condition is satisfied in response to one or more of:
a siren of the first vehicle being engaged; and
the first vehicle approaching an intersection.

8. The apparatus of claim 1, wherein the first vehicle comprises one or more of:
an emergency response vehicle;
a train; and
a public transportation vehicle.

9. An apparatus for emergency audio interception, the apparatus comprising:
a receiver module configured to detect an emergency indication from a first vehicle to a different vehicle; and
an action module configured to perform an automatic action in the different vehicle in response to the receiver module detecting the emergency indication.

10. The apparatus of claim 9, wherein the receiver module and the action module comprise a hardware device, the hardware device comprising:
one or more audio inputs configured to receive audio signals from a sound system of the different vehicle; and
one or more audio outputs configured to send the received audio signals to one or more speakers of the different vehicle, the action module configured to perform the automatic action on the received audio signals within the hardware device between the one or more audio inputs and the one or more audio outputs.

11. The apparatus of claim 9, wherein the emergency indication comprises a radio signal with a predetermined transmission radius from the first vehicle and the receiver module comprises a radio receiver configured to detect the radio signal in response to the different vehicle being within the predefined transmission radius from the first vehicle.

12. The apparatus of claim 9, wherein the emergency indication comprises an optical signal, the receiver module comprising a sensor configured to detect the optical signal.

13. The apparatus of claim 12, wherein the optical signal comprises siren lights of an emergency vehicle.

14. The apparatus of claim 12, wherein the sensor comprises a rearview camera of the different vehicle, the receiver module configured to detect a pattern of siren lights in images from the rearview camera.

15. The apparatus of claim 9, wherein the automatic action comprises powering off a sound system of the different vehicle in response to the receiver module detecting the emergency indication.

16. The apparatus of claim 15, wherein the sound system comprises one or more of a radio system, a compact disk system, and a digital video disk system.

17. The apparatus of claim 9, wherein the automatic action comprises one or more of:
a visual alert to a driver of the different vehicle; and
an auditory alert to a driver of the different vehicle.

18. A system for emergency audio interception, the system comprising:
an emergency module configured to determine that an emergency condition has been satisfied for a first vehicle;
a transmitter module configured to transmit an emergency indication from the first vehicle to a different vehicle;
a receiver module configured to detect, at the different vehicle, the emergency indication from the first vehicle; and
an action module configured to perform an automatic action for the different vehicle in response to the receiver module detecting the emergency indication.

19. The system of claim 18, further comprising the first vehicle.

20. The system of claim 18, further comprising the different vehicle.
